(19) United States
(12) Patent Application Publication
(10) Pub. No.: US 2020/0020342 A1
(43) Pub. Date: Jan. 16, 2020

(54) ERROR CONCEALMENT FOR AUDIO DATA USING REFERENCE POOLS

(71) Applicant: QUALCOMM Incorporated, San Diego, CA (US)

(72) Inventor: Brijesh Singh Tiwari, Bangalore (IN)

(21) Appl. No.: 16/034,227

(22) Filed: Jul. 12, 2018

(51) Int. Cl. G10L 19/005; H04L 29/06

(52) U.S. Cl. CPC G10L 19/005; H04L 65/607

(57) ABSTRACT

In general, techniques are described by which to perform error concealment for audio data using reference pools. A device comprising a memory and a processor may perform the techniques. The memory may store a bitstream. The processor may obtain a reference pool of one or more reference audio frames, each of the one or more reference audio frames representative of a different portion of the audio data. The processor may determine that a current audio frame is unavailable, and obtain, responsive to determining that the current audio frame is unavailable and based on a successive audio frame to the current audio frame in a bitstream, a reference audio frame of the one or more reference audio frames. The processor may replace the current audio frame with the reference audio frame, and render the reference audio frame to one or more speaker feeds.

### TECHNICAL FIELD

This disclosure relates to audio data and, more specifically, error concealment for audio data.

### BACKGROUND

Audio data is often compressed into a digital packet format prior to transmission (e.g., for audio streaming applications). Example digital packet formats include MPEG-1 Audio Layer III (MP3), MPEG-2 Audio Layer III (also denoted as MP3), Advanced Audio Coding (AAC), and the like.

Applications, such as audio streaming applications, may be on-demand and continuous while in use, and typically deliver the audio data in the digital packet format using a user datagram Protocol (UDP). UDP sends the digital packets as datagrams using minimal protocol mechanisms. UDP provides checksums to ensure data integrity, and allows port numbers for addressing different functions. However, UDP, unlike the transmission control protocol (TCP), does not guarantee delivery, packet ordering, or duplicate protection, and does not provide for any congestion control mechanisms.

As such, UDP exposes applications to any unreliability of the underlying network. In the context of audio streaming applications over unreliable networks, such as wireless local area networks (WLANs), there may be noticeable degradation of the audio data due to late arrival of packets or permanent loss of packets.

### SUMMARY

In general, techniques are described that provide a mechanism by which to perform error concealment using perceptually similar neighboring audio samples. The techniques may utilize a reference pool by which to store and reference the perceptually similar neighboring audio samples. In audio streaming applications, the techniques may provide perceptually efficient error concealment by way of the reference pool with constant worst case buffering (meaning that worst case buffering does not deviate much depending on any variables, such as the type of audio, etc.) that may improve the overall audio playback quality.

In one example, the techniques are directed to a device configured to decode a bitstream representative of audio data, the device comprising a memory configured to store the bitstream; one or more processors configured to obtain a reference pool of one or more reference audio frames, each of the one or more reference audio frames representative of a different portion of the audio data. The one or more processors are also configured to determine that a current audio frame is unavailable, and obtain, responsive to determining that the current audio frame is unavailable and based on a successive audio frame to the current audio frame in a bitstream, a reference audio frame of the one or more reference audio frames. The one or more processors are further configured to replace the current audio frame with the reference audio frame, and render the reference audio frame to one or more speaker feeds.

In another example, the techniques are directed to a method of decoding a bitstream representative of audio data, the method comprising obtaining a reference pool of one or more reference audio frames, each of the one or more reference audio frames representative of a different portion of the audio data, and determining that a current audio frame is unavailable. The method also comprises obtaining, responsive to determining that the current audio frame is unavailable and based on a successive audio frame to the current audio frame in a bitstream, a reference audio frame of the one or more reference audio frames. The method further comprises replacing the current audio frame with the reference audio frame, and rendering the reference audio frame to one or more speaker feeds.

In another example, the techniques are directed to a non-transitory computer-readable storage medium having stored thereon instructions that, when executed, cause one or more processors to: obtain a reference pool of one or more reference audio frames, each of the one or more reference audio frames representative of a different portion of audio data; determine that a current audio frame is unavailable; obtain, responsive to determining that the current audio frame is unavailable and based on a successive audio frame to the current audio frame in a bitstream, a reference audio frame of the one or more reference audio frames; replace the current audio frame with the reference audio frame; and render the reference audio frame to one or more speaker feeds.

In another example, the techniques are directed to a device configured to encode audio data, the device comprising a memory configured to store the audio data; and one or more processors configured to obtain a reference pool of one or more reference audio frames, each of the one or more reference audio frames representative of a different portion of the audio data. The one or more processors are also configured to identify a reference audio frame of the one or more reference audio frames as being perceptually similar to a current audio frame, identify, in a successive audio frame to the current audio frame in a bitstream, the reference audio frame, and output the bitstream.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a diagram illustrating a system that may perform various aspects of the techniques described in this disclosure.

FIG. 2 is a block diagram illustrating another example system that may perform various aspects of the techniques described in this disclosure.

FIG. 3 is a block diagram illustrating a transmitter of the source device shown in the example of FIG. 1 in more detail.

FIG. 4 is a block diagram illustrating a receiver of the playback device shown in the example of FIG. 1 in more detail.

FIG. 5 is a block diagram illustrating the tuple engine shown in the example of FIG. 3 in more detail.

FIG. 6 is a flowchart illustrating exemplary operation of the transmitter shown in the examples of FIGS. 1, 2, and 3.

FIG. 7 is a flowchart illustrating example operation of the receiver shown in the examples of FIGS. 1, 2, and 4.

FIG. 8 is a block diagram illustrating example components of the source device and/or the playback device shown in the example of FIG. 1.

### DETAILED DESCRIPTION

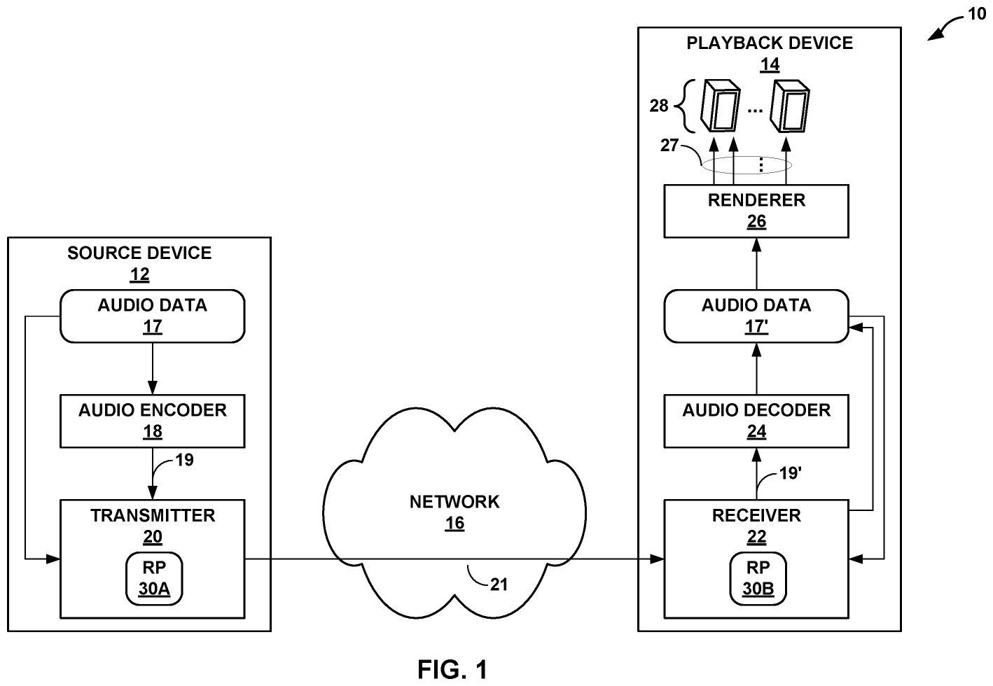

FIG. 1 is a diagram illustrating an example system 10 that may perform various aspects of the techniques described in this disclosure. As shown in the example of FIG. 1, the system 10 includes a source device 12, a playback device 14, and a network 16. The source device 12 may represent any device capable of providing audio data 17 via the network 16 to playback device 14. The source device 12 may, for example, represent a network server, a computer, a laptop computer, a mobile phone (including a so-called “smart phone”), an audio/visual (A/V) receiver, a digital video player (including a digital video disc—DVD—player, a Blueray™ player, etc.), a gaming system, a so-called smart speaker, a content provider device, a set-top box, a router, a switch, a hub, etc.

The playback device 14 may represent any device capable of receiving the audio data 17 and generating, based on the audio data 17, speaker feeds or other types of signals for reproducing a soundfield represented by the audio data 17. The playback device 14 may, for example, represent a computer, a laptop computer, a mobile phone (including a so-called “smart phone”), an audio/visual (A/V) receiver, a digital video player (including a digital video disc—DVD—player, a Blueray™ player, etc.), a gaming system, a so-called smart speaker, a set-top box, etc.

The network 16 may represent one or more devices capable of delivering the audio data 17 (which may, as one example, represent music audio data) from the source device 12 to the playback device 14. The network 16 may operate according to one or more network protocols to deliver the audio data 17 from the source device 12 to the playback device 14. The network protocols may support wired or wireless delivery of the audio data 17. The network 16 may include one or more of a network server, a router, a hub, a switch, network devices that support delivery via cellular or mobile data protocols, a media access gateway, a network access gateway, a computer, a mobile phone (including so-called “smart phones”), a so-called smart speaker, or any other device capable of executing network protocols to support delivery of the audio data 17 from the source device 12 to the playback device 14.

Although described with respect to the network 16, the techniques may be performed in systems that do not include an intervening network that is supported be devices external from the source device 12 and the playback device 14. For example, the system 10 may not include the network 16 when the source device 12 itself hosts a personal area network (PAN), such as a Bluetooth® connection, by which the playback device 14 directly interfaces with the source device 12 to retrieve the audio data 17.

As further shown in the example of FIG. 1, the source device 12 may include an audio encoder 18 and a transmitter 20. The audio encoder 18 may represent a unit configured to compress the audio data 17 in order to promote more efficient delivery of the audio data 17 via the network 16. Furthermore, the audio encoder 18 may compress the audio data 17 to conserve storage space and facilitate more efficient retrieval of the audio data 17 from storage (which may include solid state devices or drives—SSDs, hard disk devices or drives—HDDs, or other types of computer-readable storage media), thereby improving operation of the source device 12 itself by promoting energy, or in other words, power consumption via fewer processor cycles and memory bus activations.

The audio encoder 18 may compress the audio data 17 into a digital packet format prior to transmission (e.g., for audio streaming applications), specifying these packets within a bitstream representative of the audio data 17. Example digital packet formats include MPEG-1 Audio Layer III (MP3), MPEG-2 Audio Layer III (also denoted as MP3), Advanced Audio Coding (AAC), and the like. The audio encoder 18 may output the compressed audio data in the form of the bitstream 19.

The transmitter 20 may represent a unit configured to transmit the bitstream 19 via the network 16 to the playback device 14. The transmitter 20 may implement the one or more network protocols in order to deliver the bitstream 19 via the network 16 to the playback device 14. The transmitter 20 may include modulators, antennas, and other hardware by which to facilitate delivery via the network 16 in accordance with the network protocols. Although shown as the transmitter 20 in the example of FIG. 1, the transmitter 20 may be included within a transceiver, which may include the transmitter 20 along with a receiver (hence the term “transceiver”).

As also shown in the example of FIG. 1, the playback device 14 includes a receiver 22, an audio decoder 24, and a renderer 26. The receiver 22 may represent a unit configured to receive the bitstream 19 via the network 16 from the source device 12. The receiver 22 may implement the one or more network protocols in order to receive the bitstream 19 via the network 16 from the source device 12. The receiver 22 may include modulators, antennas, and other hardware by which to facilitate receipt via the network 16 in accordance with the network protocols. Although shown as the receiver 22 in the example of FIG. 1, the receiver 22 may be included within a transceiver, which may include a transmitter along with the receiver 22 (hence, again, the term “transceiver”).

The audio decoder 24 may represent a unit configured to decompress the bitstream 19 in order to enable the efficiencies provided by the audio encoder 18 discussed above. That is, absent the audio decoder 24, there would be no way by which to undo the compression provided by the audio encoder 18. In this respect, the audio decoder 24 operates in a manner reciprocal to that of the audio encoder 18 with respect to the bitstream 19 to obtain audio data 17′, where the prime notation (′) denotes that the audio data 17′ is substantially similar to the audio data 17 but may be of lower resolution due to application of lossy operations during compression performed by the audio encoder 18. The audio decoder 24 may output the decompressed audio data 17′.

The renderer 26 may each provide for a different form of rendering, where the different forms of rendering may include one or more of the various ways of performing vector-base amplitude panning (VBAP), and/or one or more of the various ways of performing soundfield synthesis. The renderer 26 may obtain, based on the audio data 17′, one or more speaker feeds 27, and output the speaker feeds 27 to one or more speakers 28. Although shown as including speakers 28, the playback device 14 may be electrically or wirelessly coupled to external speakers 28 that are not integrated or otherwise included within the playback device 14. Moreover, although represented as loudspeakers, the speakers 28 may represent any type of speaker or other transducer (including transducers integrated into earbuds, headsets, headphones, etc.) or other ways by which to induce sound via the human auditory system (including bone-conducting headphones).

As described above, the audio data 17 (which may also be referred to as “audio signals 17”) are often compressed into a digital packet format prior to transmission (e.g., for audio streaming applications). Example digital packet formats include MPEG-1 Audio Layer III (MP3), MPEG-2 Audio Layer III (also denoted as MP3), Advanced Audio Coding (AAC), and the like.

Applications, such as audio streaming applications, may be on-demand and continuous while in use, and typically deliver the audio signals in the digital packet format using a user datagram Protocol (UDP), which is one example of the above noted network protocols. UDP sends the digital packets as datagrams using a minimal protocol mechanisms. UDP provides checksums to ensure data integrity, and allows port numbers for addressing different functions. However, UDP, unlike the transmission control protocol (TCP), does not guarantee delivery, packet ordering, or duplicate protection, and does not provide for any congestion control mechanisms.

As such, UDP exposes applications to any unreliability of the underlying network, such as the network 16 in the example of FIG. 1. In the context of audio streaming applications (or other applications including audio streaming), such as video streaming applications) over unreliable networks, e.g., wireless local area networks (WLANs—particularly where many WLANs are proximate to one another, e.g., in apartments, and left in the original configuration where many of the WLANs are set to the same or adjacent channels), there may be noticeable degradation of the audio signals due to late arrival of packets or permanent loss of packets.

The techniques set forth in this disclosure may provide a mechanism by which to perform error concealment using perceptually similar neighboring audio samples. The techniques may utilize a reference pool by which to store and reference the perceptually similar neighboring audio samples. In audio streaming applications, the techniques may provide perceptually efficient error concealment by way of the reference pool with constant worst case buffering (meaning that worst case buffering does not deviate much depending on any variables, such as the type of audio, etc.) that may improve the overall audio playback quality.

To accommodate instances where memory and/or power may be limited (such as in mobile computing devices—including so-called smart-phones), the techniques may maintain the reference pool using limited amounts of memory (and power used to access and retrieve perceptually similar audio samples from the memory). In some examples, the techniques may not store current audio samples to the reference pool within the memory when the reference pool already includes reference audio samples that are similar to, if not substantially similar to, the current audio samples.

In operation, the transmitter 20 may obtain a reference pool 30A (“RP 30A”), and populate the reference pool 30A with frames of the audio data 17 (where the term “frame” refers to an “audio frame” throughout this disclosure unless otherwise specified). The frames of the audio data 17 may refer to any portion (or, in other words, number of samples) of the audio data 17. The transmitter 20 may identify a frame size, which may vary based on the digital packet format used to encode the audio data 17. The transmitter 20 may store samples of the audio signals up to the frame size as a frame of the audio data 17 (which may be referred to as a “frame”) in the reference pool 30A. The transmitter 20 may maintain the frames in the reference pool 30A for a defined period of time (e.g., the last 60 seconds of the audio data 17).

As noted above, the transmitter 20 may compare a current frame to each of the reference frames already stored to the reference pool 30A to determine whether the current frame should be added to the reference pool 30A. To determine whether the current frame should be added, the transmitter 20 may implement a matching algorithm that characterizes the current frame using some representative of the current frame, such as a tuple.

The transmitter 20 may obtain the tuple by performing any number of audio analysis algorithms. For example, the transmitter 20 may perform a spectral density estimation involving a fast Fourier transform, a modified discrete cosine transform (MDCT), or other spectral transform to obtain an estimate of the spectral density of the current frame. The transmitter 20, as another example, may determine a tonal component position of the current frame using harmonic fundamentals. The transmitter 20 may also perform masking thresholding of bark bands computed from the current frame. The transmitter 20 may also identify correlation of the current frame (in the time domain). The transmitter 20 may form the tuple from the result of one or more of the audio analysis algorithms.

The transmitter 20 may determine a similar representative for the reference frames, where again the representative may, as one example, include the above noted tuple. As such, the transmitter 20 may determine the same tuple for each of the reference frames (e.g., prior to storing the reference frames to the reference pool 30A), and also store the tuple computed from the reference frame to the reference pool 30A. The transmitter 20 may next compare the reference tuples to the current tuple to obtain a similarity score relative to each of the reference frames. Based on a comparison of the similarity scores to a similarity threshold, the transmitter 20 may not add the current frame to the reference pool 30A (such as when at least one of the similarity scores is above the similarity threshold) or may add the current frame to the reference pool 30A as one of the reference frames (when some or potentially all of the similarity scores are below the similarity threshold). In this way, the transmitter 20 may maintain a unique set of reference frames in the reference pool 30A.

Whether the current frame is added to the reference pool or not, the transmitter 20 may identify, based on the similarity scores, one of the reference frames stored in the reference pool 30A as a perceptually similar reference frame for the current frame. The audio encoding device may then identify the perceptually similar reference frame in a successive frame to the current frame (e.g., the frame following the current frame in time, which may be referred to as the “following frame”) in the bitstream 21.

In some instances, the transmitter 20 assigns an index to each reference frame stored to the reference pool 30A. The transmitter 20 may specify the index identifying the perceptually similar reference frame in the frame following the current frame in the bitstream 21. For example, the transmitter 20 may specify the index identifying the perceptually similar reference frame in a header of the following frame subsequent to the current frame in the bitstream 21. As another example, the transmitter 20 may specify the index identifying the perceptually similar reference frame as side information along with the header of the following frame subsequent to the current frame in the bitstream 21. The transmitter 20 may specify the index in the following frame rather than the current frame so that the audio decoding device 24 may quickly identify the perceptually similar reference frame (e.g., with only a single frame delay) and replace the unrecoverable current frame with the perceptually similar reference frame.

The transmitter 20 may store the current frame with an index identifying a perceptually similar reference frame for the temporally preceding frame, and the following frame with an index identifying a perceptually similar reference frame for the current frame to the bitstream 21. The transmitter 20 may update the encoded representation of the following frame in the bitstream 21 to include the index identifying the perceptually similar reference frame, and transmit the bitstream 21 to the playback device 14 via the network 16 in the manner described above.

The receiver 22 of the playback device 14 may receive the bitstream 21 and operate in a manner substantially similar to that described above with respect to the transmitter 22 to obtain a reference pool, which is denoted as reference pool 30B (“RP 30B”) in the example of FIG. 1. That is, the receiver 22 may compare a current frame to each of the reference frames already stored to the reference pool 30B to determine whether the current frame should be added to the reference pool 30B. To determine whether the current frame should be added, the receiver 22 may implement a matching algorithm that characterizes the current frame using some representative of the current frame, such as a tuple.

The receiver 22 may obtain the tuple by performing any number of audio analysis algorithms. For example, the receiver 22 may perform a spectral density estimation involving a fast Fourier transform, a modified discrete cosine transform (MDCT), or other spectral transform to obtain an estimate of the spectral density of the current frame. The transmitter 20, as another example, may determine a tonal component position of the current frame using harmonic fundamentals. The receiver 22 may also perform masking thresholding of bark bands computed from the current frame. The audio encoding device may also identify correlation of the current frame (in the time domain). The receiver 22 may form the tuple from the result of one or more of the audio analysis algorithms.

The receiver 22 may determine a similar representative for the reference frames, where again the representative may, as one example, include the above noted tuple. As such, the receiver 22 may determine the same tuple for each of the reference frames (e.g., prior to storing the reference frames to the reference pool 30B), and also store the tuple computed from the reference frame to the reference pool 30B. The receiver 22 may next compare the reference tuples to the current tuple to obtain a similarity score relative to each of the reference frames. Based on a comparison of the similarity scores to a similarity threshold, the receiver 22 may not add the current frame to the reference pool 30B (such as when at least one of the similarity scores is above the similarity threshold) or may add the current frame to the reference pool 30B as one of the reference frames (when some or potentially all of the similarity scores are below the similarity threshold). In this way, the receiver 22 may maintain a unique set of reference frames in the reference pool 30B.

The receiver 22 may also assign an index to each reference frame stored to the reference pool 30B. The receiver 22 may obtain, from the bitstream 21, the index identifying the perceptually similar reference frame in the frame following the current frame. For example, the receiver 22 may obtain the index identifying the perceptually similar reference frame from a header of the following frame subsequent to the current frame in the bitstream 21. As another example, the receiver 22 may obtain the index identifying the perceptually similar reference frame from side information specified along with the header of the following frame subsequent to the current frame in the bitstream 21.

The receiver 22 may determine that a current frame is unavailable. The current frame may be unavailable due to data corruption of the current frame that prevents successful decoding of the current frame. In this example, the audio decoding device 24 may interface with the receiver 22 to indicate that the current frame cannot be decoded, and the receiver 22 may determine that the current frame is unavailable. As another example, the receiver 22 itself may determine that the current frame was not received and was therefore lost during transmission of the bitstream 21 from the source device 12 to the playback device 14. In this example, the receiver 22 may determine that the current frame is unavailable.

In any event, the receiver 22 may obtain, responsive to determining the current frame is unavailable and based on a successive frame to the current frame in the bitstream 21 (e.g., based on the index identifying the perceptually similar reference frame to the current frame, which is specified in the header of the successive frame), the reference frame of the one or more reference frames specified in the reference pool 30B. Because the receiver 22 operates in a manner substantially similar, if not the same as, the transmitter 20 in terms of obtaining and/or maintaining the reference pool 30B (including the addition of reference frames and the assignment of indexes to the reference frames), the receiver 22 may select, e.g., based on the index specified in the header of the successive frame to the unavailable current frame in the bitstream 21, the reference frame, and replace the current frame with the reference frame.

To replace the current frame with the reference frame, the receiver 22 may provide the identified reference frame to the audio decoder 24. The audio decoder 24 may replace the current frame in a buffer or other data store to which decoded audio frames are stored with the provided reference frame. The audio decoder 24 may store (without much if any additional operations) the identified reference frame in the corresponding location of the current frame within the buffer considering that the identified reference frame has been previously decoded by the audio decoder 24. As such, the reference frames stored to the reference pool 30B (and similarly the reference pool 30A) are one or more decoded audio samples.

To illustrate how the reference pool 30B is maintained, consider the following example in which the receiver 22 may construct a similarity relation map or matching table with the information sent by the transmitter 20 as a similarity frame index in the header of each frame specified in the bitstream 21. At the beginning, this table may be filled with a one-to-one similarity map between index as shown below:

| | SIMILARITY FRAME INDEX | | | | | |
|---|---|---|---|---|---|---|
| Frame 1 | [symbol] | [symbol] | [symbol] | [symbol] | [symbol] | [symbol] |
| Frame 2 | Frame 1 | [symbol] | [symbol] | [symbol] | [symbol] | [symbol] |
| Frame 6 | Frame 2 | [symbol] | [symbol] | [symbol] | [symbol] | [symbol] |

[symbol]

indicates data missing or illegible when filed

This table may have an extended relationship map which is derived from distant neighbors. As such, the similarity relationship map may result in a table that has not only the similar frame index instructed by the transmitter 20 but also includes an extended similarity frame index that is derived from similarity occurrence of distant neighbors instructed by the transmitter 20 subsequently.

From the above table “frame 2” is indicated by the transmitter 20 as being similar to “frame 1,” and a distant neighbor “frame 6” is similar to “frame 2,” which may allow the receiver 22 to update the relationship map as follows:

| | SIMILARITY FRAME INDEX | | | | | |
|---|---|---|---|---|---|---|
| Frame 1 | [symbol] | Frame 2 | Frame 6 | [symbol] | [symbol] | [symbol] |
| Frame 2 | Frame 1 | Frame 6 | [symbol] | [symbol] | [symbol] | [symbol] |
| Frame 6 | Frame 2 | Frame 1 | [symbol] | [symbol] | [symbol] | [symbol] |

[symbol]

indicates data missing or illegible when filed

Whether the current frame is added to the reference pool 30B or not, the receiver 22 may identify lost frames (as each frame is typically assigned a sequence identifier, where each successive frame is assigned an integer that is incremented by one). That is, the audio decoding device may extract frames from the bitstream 21, and order the frames according to the sequence identifier. When one of the frames is unavailable (or, in other words, lost or unrecoverable), the receiver 22 may access the following frame to identify the index of the perceptually similar audio frame.

Using the index as a key into the reference pool 30B, the receiver 22 may quickly identify the perceptually similar audio frame stored as one of the reference frames in the reference pool. The receiver 22 may next replace the lost frame with the reference frame identified by the index of the perceptually similar audio frame in the manner described above. The renderer 26 may obtain the decoded frame from the frame buffer or other data store and render the reference audio frame (that was used in place or, in other words, as a replacement to the current frame) to one or more speaker feeds 27 in the manner described above.

In this manner, the playback device 14 may quickly (e.g., only injecting a jitter buffer delay as small as a delay to receive the next or, in other words, following frame) perform error concealment to replace the lost frame with the perceptually similar audio frame with overlap and add to the previous frame. Overlap and add is by design part of some codec such as AAC, MP3 which uses MDCT internally so that frame discontinuity may not become an issue. But codecs which do not apply overlap and add based synthesis, may need extra delay (which will be less than 1 frame delay required for the filtering operation) to perform waveform synthesis to remove frame discontinuity. As such, the techniques may provide perceptually efficient error concealment by way of the reference pool with constant worst case buffering (meaning that worst case buffering does not deviate much depending on any variables, such as the type of audio, etc.) that may improve the overall audio playback quality.

While shown in FIG. 1 as being directly transmitted to the playback device 14, the source device 12 may output the bitstream 21 to an intermediate device positioned between the source device 12 and the playback device 14. The intermediate device may store the bitstream 21 for later delivery to the content consumer 14, which may request this bitstream 21. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the playback device 14, requesting the bitstream 21.

Alternatively, the source device 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 1.

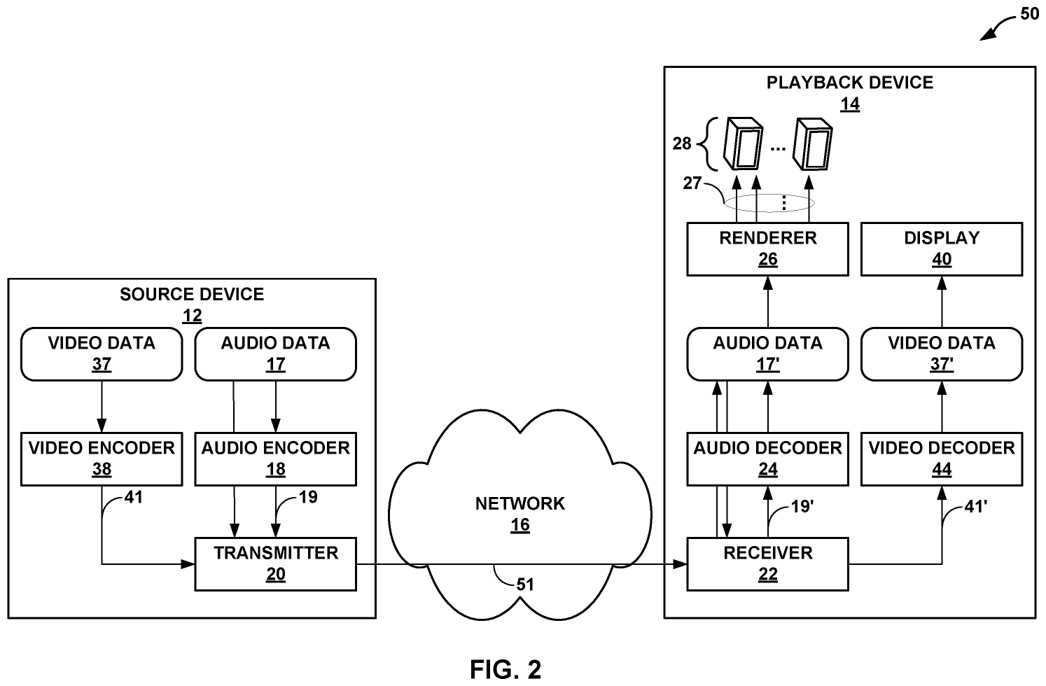

FIG. 2 is a block diagram illustrating another example system 50 that may perform various aspects of the techniques described in this disclosure. The system 50 is similar to the system 10 shown in the example of FIG. 1, except that rather than provide audio streaming service in the manner discussed above with respect to the system 10, the system 50 provides video streaming along with audio streaming (where the combined video and audio streaming is typically referred to as a “video streaming service”).

In the example of FIG. 2, the source device 12 is shown as further including a video encoder 38. The video encoder 38 may represent a unit configured to compress (or, in other words, encode) video data 37 to obtain a video bitstream 41. The video encoder 38 may implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to High Efficiency Video Coding (HEVC)), and extensions of such standards. The audio data 17 may correlate with the video data 37, and the resulting audio bitstream 19 obtained by the audio encoder 18 may be synchronized (e.g., via timestamp) to the video bitstream 41.

The transmitter 20 may assemble media data (e.g., the audio bitstream 19 and/or the video bitstream 41) may be assembled into a video file conforming to any of a variety of standards, such as the International Organization for Standardization (ISO) base media file format and extensions thereof, such as AVC. The transmitter 20 may implement Dynamic Adaptive Streaming over HTTP (DASH), which describes the use of segments as deliverable containers of media data (e.g., files with unique uniform resource locators (URLs)). Segments have a type, described by a “segment type” or “styp” syntax element. Files also have a file type, described by a “file type” or “ftyp” syntax element. Such syntax elements may form part of file format information according to, e.g., the ISO base media file format (ISO BMFF) or an extension of ISO BMFF.

A file conforming to ISO BMFF or an extension of ISO BMFF may further include media data formatted according to Common Media Application Format (CMAF). CMAF content is used in different stages: at the content preparation stage, at the delivery level, and at the content consumption stage (e.g., for an interface to a receiving device, such as a media source extension (MSE) interface). The transmitter 20 may output a DASH compliant, or other file formatted, bitstream 51.

As further shown in the example of FIG. 2, the playback device 14 of the system 50 is similar to the playback device 14 of the system 21 except that the playback device 14 also includes a video processing path that includes a video decoder 44 and display 40. Although shown as being a single device 14, the playback device 14 may represent one or devices, such as an A/V receiver (e.g., that includes the audio processing path of the audio decoder 24, the renderer 26, and the speakers 28) and a smart television (e.g., that includes the video processing path). The receiver 22 in this playback device 14 may be included in one of the multiple devices depending on how the playback device 14 is configured. The receiver 22 may output the audio bitstream 19′ to the audio processing path, and the video bitstream 41′ to the video processing path.

In any event, the video decoder 44 may represent a unit configured to perform decoding in a manner reciprocal to the video encoding performed by the video encoder 38 to obtain video data 37′ from the video bitstream 41′, where the prime notation again denotes that the data 37′/bitstream 41′ is substantially similar to the video data 37 /video bitstream 41 but for errors introduced due to corruption, loss, and other operations. The video decoder 44 may output the video data 37′ to the display 40. The display 40 may represent a unit configured to display, using various technologies (e.g., light emitting diode—LED, organic LED—OLED, etc.), the video data 37′.

Although described with respect to audio streaming services, the techniques may in this respect also apply to video streaming services. Moreover, although not explicitly illustrated (for ease of illustration purposes), the techniques may be extended to any type of streaming service that includes some form of audio streaming, whether as a standalone service or in combination with one or more other multimedia streaming services.

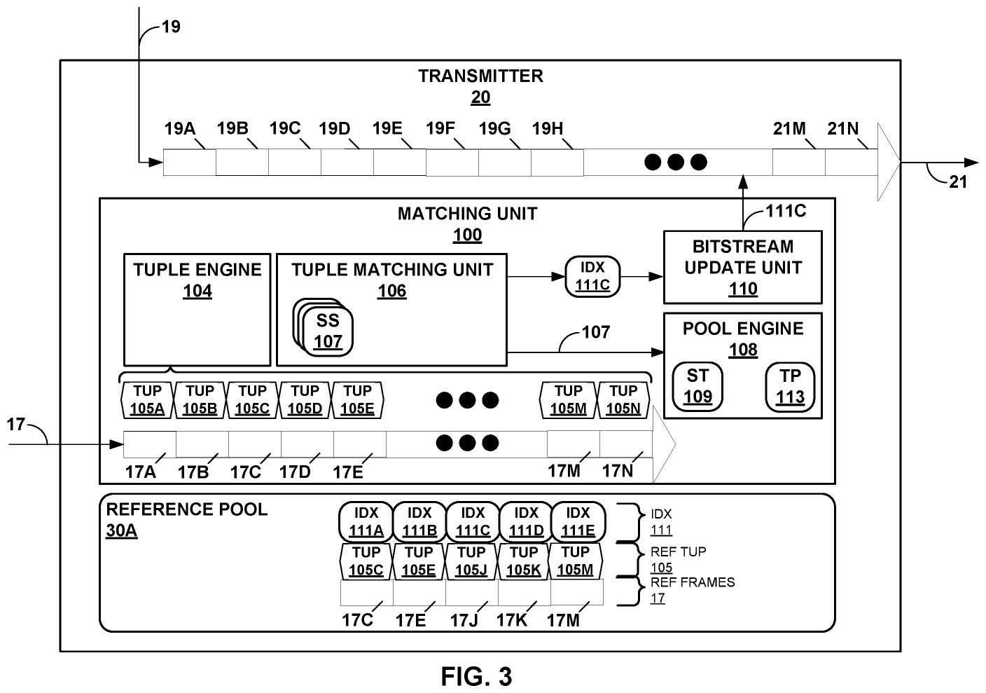

FIG. 3 is a block diagram illustrating a transmitter of the source device shown in the example of FIG. 1 in more detail. As shown in the example of FIG. 3, the transmitter 20 includes a matching unit 100 and the reference pool 30A. The matching unit 100 may represent a unit configured to perform perceptual audio matching with respect to a current frame relative to reference frames stored to the reference pool 30A in order to maintain the reference pool 30A and provide perceptual audio error concealment consistent with various aspects of the techniques described in this disclosure.

As further shown in the example of FIG. 3, the matching unit 100 may include a tuple engine 104, a tuple matching unit 106, a pool engine 108, and a bitstream update unit 110. The tuple engine 104 represents a unit configured to generate tuples (“TUP”) 105A-105N (“tuples 105”), or some other representative, for frames 17A-17N of the audio data 17 (“frames 17,” which is also another way of referring to audio data 17). The tuple engine 104 may perform, as noted above, a spectral density estimation involving a fast Fourier transform, a modified discrete cosine transform (MDCT), or other spectral transform to obtain an estimate of the spectral density of the current frame. The tuple engine 104 may, as another example, determine a tonal component position of the current frame using harmonic fundamentals. The tuple engine 104 may also perform masking thresholding of bark bands computed from the current frame. The tuple engine 104 may also identify correlation of the current frame (in the time domain). The tuple engine 104 may obtain each of the tuples 105 from the result of one or more of the audio analysis algorithms as applied to each of the frames 17. The tuple engine 104 may provide the tuples 105 to the tuple matching unit 106.

The tuple matching unit 106 may represent a unit configured to identify a perceptually similar match for the current one of the frames 17 (which may be referred to as a “current frame 17”) based on one of tuples 105 associated with the current frame (which may be referred to as the “current tuple 105”) and the tuples 105 associated with those of frames 17 stored to the reference pool 30A. The frames 17 stored to the reference pool 30A may be referred to as “reference frames 17” (shown as “REF FRAMES 17”) while the tuples 105 associated with the reference frames 17 may be denoted as “reference tuples 105” (shown as “REF TUP 105”).

To perform the match, the tuple matching unit 106 may determine a similarity score (“SS”) 107 for the current tuple 105 as compared to each of the reference tuples 105. For example, the tuple matching unit 106 may determine the similarity scores 107 as a Euclidian distance between the current tuple 17 and each of the reference tuples 17 stored to the reference pool 30A. The tuple matching unit 106 may identify, based on the similarity scores 107, one of indexes 111A-111E (“indexes 111”) assigned to reference tuples 17 (and by association, reference frames 17) stored to the reference pool 30A.

To illustrate, the tuple matching unit 106 may select the highest one of similarity scores 107 (relative to the other similarity scores 107 computed for the current tuple 105), and identify the one of indexes 111 associated with the reference tuple 105 from which the highest one of the similarity scores 107 was determined. In the example of FIG. 3, it is assumed that the reference tuple 105J resulted in the highest one of similarity scores 107, and as such the tuple matching unit 106 outputs the one of indexes 111 associated with the reference tuple 105J (i.e., the index 111C in the example of FIG. 3) to the bitstream update unit 110. The tuple matching unit 106 may also output the similarity scores 107 computed for the current tuple 105 (and the associated current frame 17) to the pool engine 108.

The pool engine 108 may represent a unit configured to obtain (and thereafter maintain) the reference pool 30A. The pool engine 108 may receive the similarity scores 107 and compare the similarity scores 107 to a similarity threshold (“ST”) 109. Based on the comparison of the similarity scores 107 to the similarity threshold 109, the pool engine 108 may add the current frame 17 to the reference pool 30A as one of the reference frames 17, along with the current tuple 105 as one of the reference tuples 105. The pool engine 108 may then assign a new index 111 to the current frame 17 (as one of the reference frames 17) within the reference pool 30A.

In the example of FIG. 3, the pool engine 108 is assumed to have added frames 17C, 17E, 17J, 17K, and 17M along with the associated tuples 105C, 105E, 105J, 105K, and 105M to the reference pool 30A as the reference frames 17 and the reference tuples 105, respectively. The pool engine 108 may, after adding each one of the reference frames 17, assign one of indexes 111 to the reference frames 17. The pool engine 108 may systematically add the current frame 17 and the associated current tuple 105 to the reference pool 30A such that the receiver 22 may duplicate the reference pool 30A at any given point in processing audio data 17′. As such, the transmitter 20 and the receiver 22 may maintain synchronization of the reference pools 30A and 30B (where synchronization is understood to refer to synchronization relative to the frames 19/21 of the bitstream 19/21 and not actual time-based synchronization) through systematic analysis of the respective audio data 17 and 17′ without potentially introducing much if any overhead (other than signaling of indexes identifying the perceptually similar reference frames 17) in the form of syntax elements or other metadata.

In one example, when all (or in some instances, some percentage—such as 10% or 15%) of the similarity scores 107 calculated for the current frame 17 are below the similarity threshold 109, the pool engine 108 may add the current frame 17 to the reference pool 30A. The pool engine 108 may next add the current tuple 105 to the reference pool 30A. The pool engine 108 may then increment the last assigned one of the indexes 111, and assign the incremented one of the indexes 111 to the most recently added reference frame 17 (which is the current frame 17 in this example). In this example, when one (or in some instances, some percentage—such as 80% or 90%) of the similarity scores 107 calculated for the current frame 17 are above or equal to the similarity threshold 109, the pool engine 108 may refrain from adding the current frame 17 to the reference pool 30A.

The pool engine 108 may additionally remove one or more of the reference frames 17 (along with the associated one of tuples 105 and indexes 111) from the reference pool 30A. For example, the pool engine 108 may compare a timestamp associated with each of the reference frames 17 to a timestamp associated with the current frame 17 (where such timestamps may be specified in a header of the frames 17) to obtain, for each of the reference frames 17, an elapsed time.

The pool engine 108 may remove, based on a comparison of each of the elapsed times to a time period (“TP”) 113, respective ones of the reference frames 17. For example, when one of the elapsed times exceeds the time period 113, the pool engine 108 may remove, from the reference pool 30A, the corresponding one of the reference frames 17 (along with the associated one of tuples 105 and indexes 111) from which the one of the elapsed times was calculated. Removal of the reference frames 17 from the reference pool 30A may reduce memory consumption or otherwise reduce the amount of memory required to maintain the reference pool 30A.

The bitstream update unit 110 may represent a unit configured to update the audio bitstream 19 to include the indexes 111 identified by the tuple matching unit 106. The bitstream update unit 110 may update the frames 19A-19N (which is shown in updated form as updated frame 21N) of the audio bitstream 19 to include the index identified for the preceding frames 19B-19O (where frame 19O is not shown for ease of illustration purposes). The bitstream update unit 110 may update a header of each of the frames 19A-19N to include the index identified for the temporally preceding one of the frames 19B-190. In this respect, the bitstream update unit 110 may transition, frame-by-frame, the audio bitstream 19 into the audio bitstream 21.

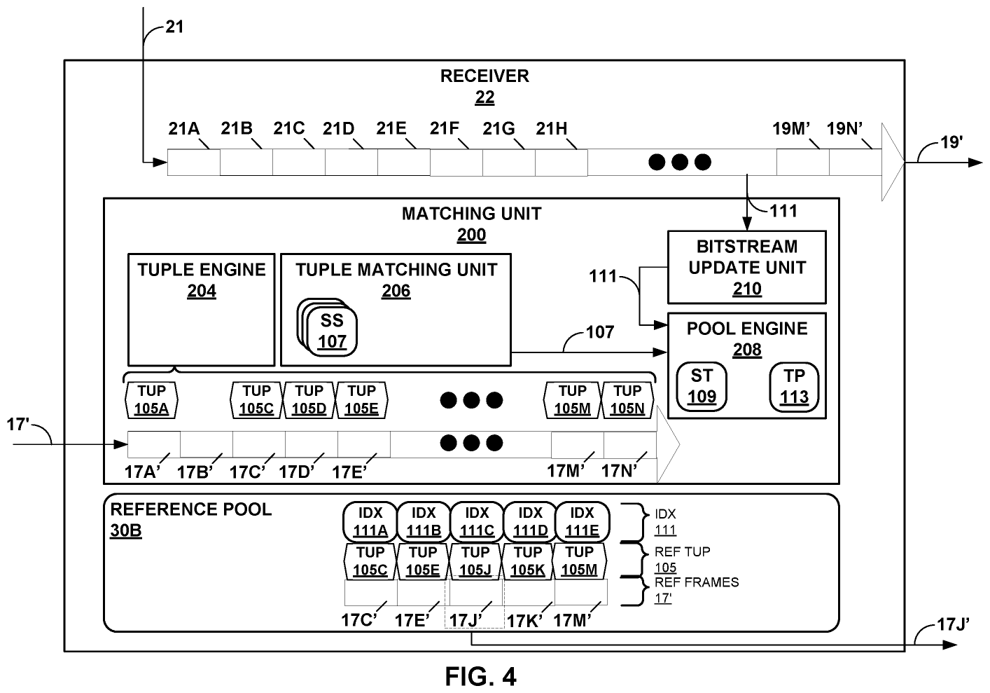

FIG. 4 is a block diagram illustrating a receiver of the playback device shown in the example of FIG. 1 in more detail. As shown in the example of FIG. 4, the receiver 20 includes a matching unit 200 and the reference pool 30B. The matching unit 200 may represent a unit configured to perform perceptual audio matching with respect to a current frame relative to reference frames stored to the reference pool 30B in order to maintain the reference pool 30B and provide perceptual audio error concealment consistent with various aspects of the techniques described in this disclosure.

As further shown in the example of FIG. 4, the matching unit 200 may include a tuple engine 204, a tuple matching unit 206, a pool engine 208, and a bitstream update unit 210. The tuple engine 204 represents a unit configured to operate in a manner similar to, if not the same as, the tuple engine 104 discussed above. That is, the tuple engine 204 may generate tuples (“TUP”) 105A-105N (“tuples 105”), or some other representative, for frames 17A′-17N′ of the audio data 17′ (“frames 17′,” which is also another way of referring to audio data 17′). The tuple engine 204 may perform, as noted above, a spectral density estimation involving a fast Fourier transform, a modified discrete cosine transform (MDCT), or other spectral transform to obtain an estimate of the spectral density of the current frame. The tuple engine 204 may, as another example, determine a tonal component position of the current frame using harmonic fundamentals. The tuple engine 204 may also perform masking thresholding of bark bands computed from the current frame. The tuple engine 204 may also identify correlation of the current frame (in the time domain). The tuple engine 204 may obtain each of the tuples 105 from the result of one or more of the audio analysis algorithms as applied to each of the frames 17′. The tuple engine 204 may provide the tuples 105 to the tuple matching unit 206.

The tuple matching unit 206 may represent a unit configured to operate in a manner similar to the tuple matching unit 106 discussed above, except that the tuple matching unit 206 does not identify the indexes 111 of the perceptually similar reference frame as the indexes 111 are specified in the bitstream 21 in the manner discussed above. As such, the tuple matching unit 206 may identify a perceptually similar match for the current one of the frames 17′ (which may be referred to as a “current frame 17′”) based on one of tuples 105 associated with the current frame (which may be referred to as the “current tuple 105”) and the tuples 105 associated with those of reference frames 17′ stored to the reference pool 30B. The frames 17′ stored to the reference pool 30B may be referred to as “reference frames 17′” (shown as “REF FRAMES 17′”) while the tuples 105 associated with the reference frames 17′ may be denoted as “reference tuples 105” (shown as “REF TUP 105”).

To perform the match, the tuple matching unit 206 may determine a similarity score (“SS”) 107 for the current tuple 17 as compared to each of the reference tuples 17. For example, the tuple matching unit 106 may determine the similar scores 107 as a Euclidian distance between the current tuple 105 and each of the reference tuples 105 stored to the reference pool 30B. The tuple matching unit 106 may output the similarity scores 107 computed for the current tuple 105 (and the associated current frame 17) to the pool engine 108.

The pool engine 208 may represent a unit configured to perform operations similar to, if not the same as, the pool engine 108. That is, the pool engine 208 may obtain (and thereafter maintain) the reference pool 30B. The pool engine 208 may receive the similarity scores 107 and compare the similarity scores 107 to a similarity threshold (“ST”) 109. Based on the comparison of the similarity scores 107 to the similarity threshold 109, the pool engine 208 may add the current frame 17′ to the reference pool 30B as one of the reference frames 17′, along with the current tuple 105 as one of the reference tuples 105. The pool engine 208 may then assign a new index 111 to the current frame 17′ (as one of the reference frames 17′) within the reference pool 30B.

In the example of FIG. 4, the pool engine 208 is assumed to have added frames 17C,′ 17E,′ 17J,′ 17K,′ and 17M′ along with the associated tuples 105C, 105E, 105J, 105K, and 105M to the reference pool 30B as the reference frames 17′ and the reference tuples 105 respectively. The pool engine 208 may, after adding each one of the reference frames 17′, assign one of indexes 111 to the reference frames 17′, performing the same operations as the pool engine 108 of the transmitter 20. The pool engine 208 may systematically add the current frame 17′ and the associated current tuple 105 to the reference pool 30B such that the receiver 22 may duplicate the reference pool 30A of the transmitter 20 at any given point in processing audio data 17, thereby maintaining synchronization with the transmitter 20 (where synchronization is again understood to refer to synchronization relative to the frames 19′/21 of the bitstream 19′/21 and not actual time-based synchronization).

In one example, when all (or in some instances, some percentage—such as 10% or 15%) of the similarity scores 107 calculated for the current frame 17′ are below the similarity threshold 109, the pool engine 208 may add the current frame 17′ to the reference pool 30B. The pool engine 208 may next add the current tuple 105 to the reference pool 30B. The pool engine 208 may then increment the last assigned one of the indexes 111, and assign the incremented one of the indexes 111 to the most recently added reference frame 17′ (which is the current frame 17′ in this example). In this example, when one (or in some instances, some percentage—such as 80% or 90%) of the similarity scores 107 calculated for the current frame 17′ are above or equal to the similarity threshold 109, the pool engine 208 may refrain from adding the current frame 17′ to the reference pool 30B.

The pool engine 208 may additionally remove one or more of the reference frames 17′ (along with the associated one of tuples 105 and indexes 111) from the reference pool 30B. For example, the pool engine 208 may compare a timestamp associated with each of the reference frames 17′ to a timestamp associated with the current frame 17′ (where such timestamps may be specified in a header of the frames 17) to obtain, for each of the reference frames 17′, an elapsed time.

The pool engine 208 may remove, based on a comparison of each of the elapsed times to a time period (“TP”) 113, respective ones of the reference frames 17′. For example, when one of the elapsed times exceeds the time period 113, the pool engine 208 may remove, from the reference pool 30B, the corresponding one of the reference frames 17′ (along with the associated one of tuples 105 and indexes 111) from which the one of the elapsed times was calculated. Removal of the reference frames 17′ from the reference pool 30B may reduce memory consumption or otherwise reduce the amount of memory required to maintain the reference pool 30B.

The bitstream update unit 210 may represent a unit configured to operate in a manner reciprocal to that of the bitstream update unit 110. That is, the bitstream update unit 210 may update the bitstream 21 to remove the indexes 111 identified by the tuple matching unit 106. The bitstream update unit 210 may update the frames 21A-21N (which is shown in updated form as updated frame 19N′) of the audio bitstream 21 to parse the index identified for the preceding frames 21B-21O (where frame 21O is not shown for ease of illustration purposes). The bitstream update unit 21O may update a header of each of the frames 21A-21N to remove or otherwise parse the index identified for the temporally preceding one of the frames 21B-21O. In this respect, the bitstream update unit 210 may transition, frame-by-frame, the audio bitstream 21 into the audio bitstream 19′.

The bitstream update unit 210 may determine and provide the parsed indexes 111 to the pool engine 208 along with indications from which of the frames 21 the indexes 111 were parsed. The pool engine 208 may maintain the indexes for the time period 113 or some other period of time, buffering the indexes 111 in the event that one of the frames 19′ was corrupted (and therefore unrecoverable) or lost. The audio decoder 24 may interface, in the event one of the frames 19′ is lost or unrecoverable, the pool engine 208 to provide an indication indicating that the one of the frames 19′ was lost.

The pool engine 208 may access the buffered indexes 111 identifying the one of indexes 111 corresponding to the one of frames 19′ subsequent to the lost or corrupted one of the frames 19′. Using the identifying one of the indexes 111, the pool engine 208 may access the reference pool 30B to provide the perceptually similar reference frame 17′ (which in this instance is assumed to be the reference frame 17J′) to the audio decoder 24. The audio decoder 24 may then output the reference frame 17J′ in place of the lost or unavailable current frame 17′, thereby performing perceptual error concealment with respect to the current frame 17′.

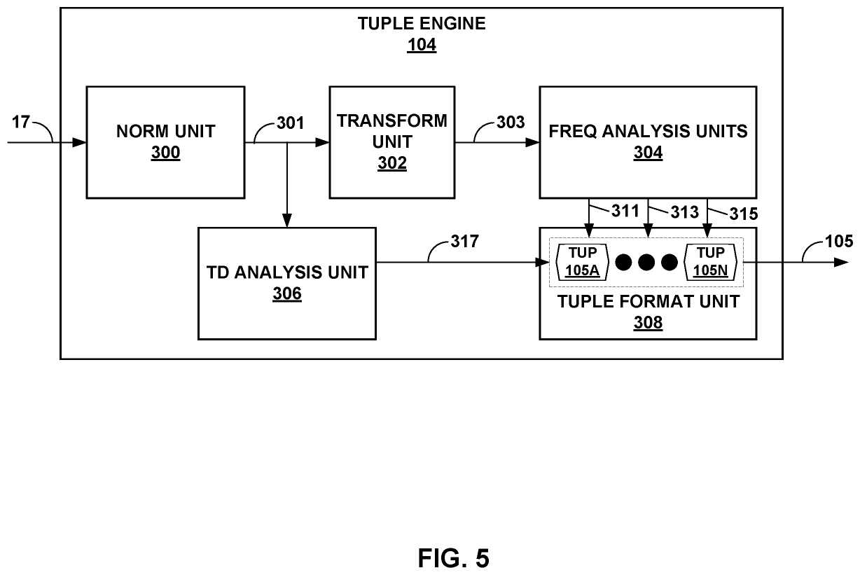

FIG. 5 is a block diagram illustrating the tuple engine shown in the example of FIG. 3 in more detail. Although described with respect to the tuple engine 104, the following discussion may apply equally to the tuple engine 204 shown in the example of FIG. 4 considering that the tuple engine 204 may perform substantially similar, if not the same, operations as those described with respect to the tuple engine 104.

As shown in the example of FIG. 5, the tuple engine 104 includes a normalization unit (“NORM UNIT”) 300, a transform unit 302, a frequency (“FREQ”) analysis unit 304, a time-domain (“TD”) analysis unit 306, and a tuple format unit 308. The normalization unit 300 may represent a unit configured to perform some form of normalization with respect to the audio frames 17 to obtain normalized audio frames 301. The normalization unit 300 may, for example, perform a root-mean-squared (RMS) normalization with respect to each of the audio frames 17 to obtain the normalized audio frames 301. The normalization unit 300 may output the normalized audio frames 301 to the transform unit 302 and the TD analysis unit 306.

The transform unit 302 may represent a unit configured to transform each of the normalized audio frames 301 from the spatial domain to the frequency domain, thereby obtaining transformed audio frames 303. The transform unit 302 may perform, as one example, a fast Fourier transform (FFT) with respect to each of the normalized audio frames 301 to obtain the transformed audio frames 303. The transform unit 302 may output the transformed audio frames to the frequency analysis unit 304.

The frequency analysis unit 304 may perform, as noted above, a spectral density estimation involving a fast Fourier transform, a modified discrete cosine transform (MDCT), or other spectral transform to obtain an estimate of the spectral density (“spectral density estimate 311”) of the current frame. The frequency analysis unit 304 may, as another example, determine a tonal component position 313 of the current frame using harmonic fundamentals. The frequency analysis unit 304 may also perform masking thresholding of bark bands computed from the current frame to obtain masked bark bands 315. The frequency analysis unit 304 may output one or more of the spectral density estimate 311, the tonal component position 313, and the masked bark bands 315 to the tuple format unit 308.

The TD analysis unit 306 may represent a unit configured to perform time domain analysis with respect to the normalized audio frames 301. The TD analysis unit 306 may, as one example, identify correlation 317 of the current frame (in the time domain). The TD analysis unit 306 may output the correlation 317 to the tuple format unit 308.

The tuple format unit 308 may represent a unit configured to format one or more of the spectral density estimate 311, the tonal component position 313, the masked bark bands 315, and the correlation 317, and thereby form the tuples 105. The tuple format unit 308 may output the tuples for further processing by the tuple matching unit 106. As described above, the tuple engine 204 may operate in a similar, if not the same manner, to obtain the same tuples 105 at the receiver 22. The tuple engine 204 may include similar units 300-308 as that described above with respect to the tuple engine 104, each of which perform the same operations as that described above with respect to the units 300-308.

The tuple engine 104 may obtain each of the tuples 105 from the result of one or more of the audio analysis algorithms as applied to each of the frames 17. The tuple engine 104 may provide the tuples 105 to the tuple matching unit 106.

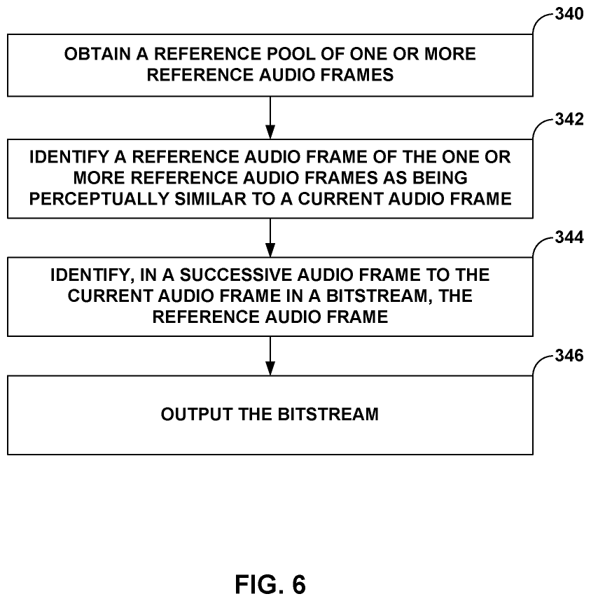

FIG. 6 is a flowchart illustrating exemplary operation of the transmitter shown in the examples of FIGS. 1, 2, and 3. As discussed above, the transmitter may first obtain a reference pool 30A of one or more reference audio frames 17 (340). Each of the one or more reference audio frames 17 may be representative of a different portion of the audio data 17. The transmitter 17 may next identify a reference audio frame 17 of the one or more of the reference audio frames 17 as being perceptually similar to a current audio frame 17 (342). The transmitter 17 may then identify, in a successive audio frame 19 to the current audio frame 17 in the bitstream 21, the identified reference audio frame 17 (344). The transmitter 17 may output the bitstream 21 (346).

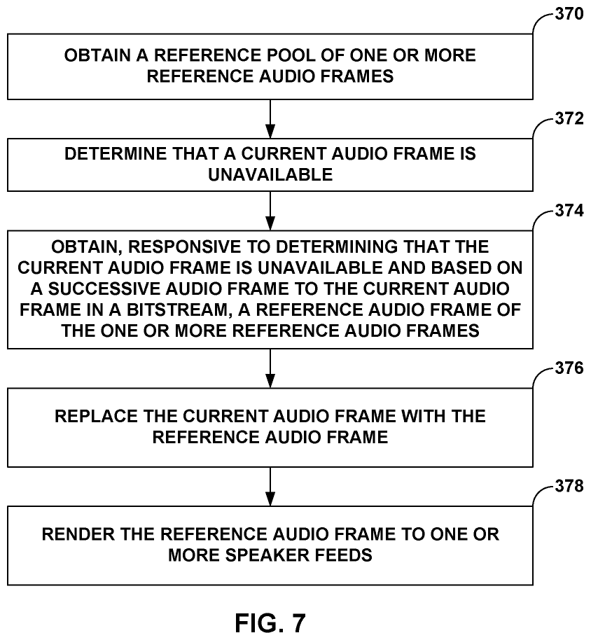

FIG. 7 is a flowchart illustrating example operation of the receiver shown in the examples of FIGS. 1, 2, and 4. The receiver 22 may, as described above, obtain a reference pool 30B of one or more reference audio frames 17′ (370). The receiver 22 may determine that a current audio frame 21 is unavailable in any of the example ways described above (372).

The receiver 22 may obtain, responsive to determining that the current audio frame 17′ is unavailable and based on a successive audio frame 21 to the current audio frame 21 in the bitstream 21, a reference audio frame 17′ of the one or more reference audio frames 17′ (374). The receiver 22 may interface with the audio decoder 24 to replace the current audio frame 17′ with the reference audio frame 17′ (376). The renderer 26 may render the reference audio frame 17′ to one or more speaker feeds 27 (378).

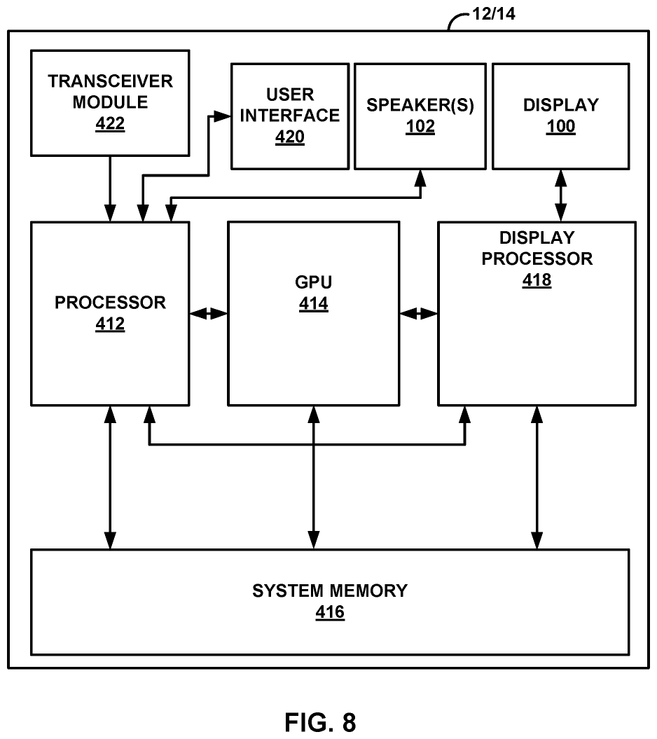

FIG. 8 is a block diagram illustrating example components of the source device and/or the playback device shown in the example of FIG. 1. In the example of FIG. 8, the source device 12 and/or the playback device 14 includes a processor 412, a graphics processing unit (GPU) 414, system memory 416, a display processor 418, one or more integrated speakers 102, a display 100, a user interface 420, and a transceiver module 422 (which may represent one example of the transmitter 20 or the receiver 22). In examples where the source device 12 is a mobile device, the display processor 418 is a mobile display processor (MDP). In some examples, such as examples where the source device 12 is a mobile device, the processor 412, the GPU 414, and the display processor 418 may be formed as an integrated circuit (IC).

For example, the IC may be considered as a processing chip within a chip package, and may be a system-on-chip (SoC). In some examples, two of the processors 412, the GPU 414, and the display processor 418 may be housed together in the same IC and the other in a different integrated circuit (i.e., different chip packages) or all three may be housed in different ICs or on the same IC. However, it may be possible that the processor 412, the GPU 414, and the display processor 418 are all housed in different integrated circuits in examples where the source device 12 is a mobile device.

Examples of the processor 412, the GPU 414, and the display processor 418 include, but are not limited to, one or more digital signal processors (DSPs), general purpose microprocessors, application specific integrated circuits (ASICs), field programmable logic arrays (FPGAs), or other equivalent integrated or discrete logic circuitry. The processor 412 may be the central processing unit (CPU) of the source device 12 and/or playback device 14. In some examples, the GPU 414 may be specialized hardware that includes integrated and/or discrete logic circuitry that provides the GPU 414 with massive parallel processing capabilities suitable for graphics processing. In some instances, GPU 14 may also include general purpose processing capabilities, and may be referred to as a general purpose GPU (GPGPU) when implementing general purpose processing tasks (i.e., non-graphics related tasks). The display processor 418 may also be specialized integrated circuit hardware that is designed to retrieve image content from the system memory 416, compose the image content into an image frame, and output the image frame to the display 100.

The processor 412 may execute various types of the applications 20. Examples of the applications 20 include web browsers, e-mail applications, spreadsheets, video games, other applications that generate viewable objects for display, or any of the application types listed in more detail above. The system memory 416 may store instructions for execution of the applications 20. The execution of one of the applications 20 on the processor 412 causes the processor 412 to produce graphics data for image content that is to be displayed and the audio data 21 that is to be played (possibly via integrated speaker 102). The processor 412 may transmit graphics data of the image content to the GPU 414 for further processing based on and instructions or commands that the processor 412 transmits to the GPU 414.

The processor 412 may communicate with the GPU 414 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and the processor 412 and the GPU 414 may utilize any technique for communication.

The system memory 416 may be the memory for the source device 12. The system memory 416 may comprise one or more computer-readable storage media. Examples of the system memory 416 include, but are not limited to, a random access memory (RAM), an electrically erasable programmable read-only memory (EEPROM), flash memory, or other medium that can be used to carry or store desired program code in the form of instructions and/or data structures and that can be accessed by a computer or a processor.

In some aspects, the system memory 416 may include instructions that cause the processor 412, the GPU 414, and/or the display processor 418 to perform the functions ascribed in this disclosure to the processor 412, the GPU 414, and/or the display processor 418. Accordingly, the system memory 416 may be a computer-readable storage medium having instructions stored thereon that, when executed, cause one or more processors (e.g., the processor 412, the GPU 414, and/or the display processor 418) to perform various functions.

The system memory 416 may include a non-transitory storage medium. The term “non-transitory” indicates that the storage medium is not embodied in a carrier wave or a propagated signal. However, the term “non-transitory” should not be interpreted to mean that the system memory 416 is non-movable or that its contents are static. As one example, the system memory 416 may be removed from the source device 12 and/or the playback device 14, and moved to another device. As another example, memory, substantially similar to the system memory 416, may be inserted into the source device 12. In certain examples, a non-transitory storage medium may store data that can, over time, change (e.g., in RAM).

The user interface 420 may represent one or more hardware or virtual (meaning a combination of hardware and software) user interfaces by which a user may interface with the source device 12 and/or the playback device. The user interface 420 may include physical buttons, switches, toggles, lights or virtual versions thereof. The user interface 420 may also include physical or virtual keyboards, touch interfaces—such as a touchscreen, haptic feedback, and the like.

The processor 412 may include one or more hardware units (including so-called “processing cores”) configured to perform all or some portion of the operations discussed above with respect to one or more of the mixing unit 22, the audio encoder 24, the wireless connection manager 26, the audio manager 28, and the wireless communication units 30. The transceiver module 422 may represent a unit configured to perform various aspects of the techniques described above with respect to the source device 12 and/or the playback device 14. The transceiver module 422 may represent one or more receivers and one or more transmitters capable of wireless communication in accordance with one or more wireless communication protocols.

The transmission of audio signals in the compressed digital packet format in streaming application is increasing day by day. But such continuous media applications typically use User Datagram Protocol (UDP), which does not provide a congestion control mechanism. Real-time digital audio streaming over unreliable wireless IP networks, such as WLANs, may encounter playback quality degradation, due to late arrivals or permanent loss of the transmitted packets.

A system, as described above, is designed with an error concealment algorithm for a lost packet or group of packet. The techniques may give a perceptually efficient error concealment technique with constant worst case buffering which can significantly improve the overall audio playback quality of typical wireless audio streaming systems. Audio data is non stationary over the long term, but can have high correlation with neighboring frames of within a 1 second interval. The reference frame pool is updated by new neighboring frames of 1 second duration.

At the transmitter side, perceptual similarity of the current frame is compared to the updated pool of reference frames, which is continuously upgraded from past frames and the matching index information about the current frame is sent as header information in the next frames. On the receiver side, a similar reference frames buffer pool is maintained, from where the matching index of lost packets is retrieved and then the most perceptual similar frame is substituted. This algorithm is applied on audio codec which uses TDAC windowlike MPEG-2 AAC encoder where frame discontinuity does not appear due to overlap and add mechanism. Extra information for matching index will be sent from transmitter along with encoded frames and this index information will cost extra bits per frame depending upon size of reference frame pool.

The computation complexity at the transmitter may increase and no extra delay may be required as the size of the reference frame pool is tied to buffering at the receiver side. At the decoder, synthesizing of frame will not add extra complexity as it comes into picture when decoding of frame is skipped.

In an AAC codec, an audio signal is decomposed into smaller frames (2048) with 50% overlap and MDCT is calculated. Each frame's MDCT coefficients are passed through the matching algorithm where they get compared against available MDCT coefficients of reference frame pool.

The matching algorithm gives an index of the most perceptually similar frame. This index information is sent as side info along with next frame's header. If due to network jitter the current frame is lost, then concealment will be done by replacing the lost frame by a most perceptually similar frame.

Matching Algorithm: The first measure for matching is energy level. Current frame's bins energy is compared against all stored frame's bins energy. The most similar frame is picked and then if energy difference is less than a masking threshold of current frame, its reference frame index is transmitted along with next frame data. This process keeps on running with updating bit pool with 1 second of data.

At the receiver, a similarity relation map is created to maintain a relation info table of current frame with other frames. The reference frame pool is updated by MDCT coefficients of 1 sec duration. If any frame is lost, then corresponding matching frames MDCT coefficients are picked from a reference frame pool and fed to decoder block.

The foregoing techniques may be performed with respect to any number of different contexts and audio ecosystems. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into various representations for playback by one or more of the playback elements. For instance, a user of the mobile device may record (acquire a soundfield of) a live event (e.g., a meeting, a conference, a play, a concert, etc.), and code the recording into various representation, including higher order ambisonic HOA representations.

The mobile device may also utilize one or more of the playback elements to playback the coded soundfield. For instance, the mobile device may decode the coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a headset or headphones, e.g., to create realistic binaural sound.

In some examples, a particular mobile device may both acquire a soundfield and playback the same soundfield at a later time. In some examples, the mobile device may acquire a soundfield, encode the soundfield, and transmit the encoded soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of audio signals. For instance, the one or more DAWs may include audio plugins and/or tools which may be configured to operate with (e.g., work with) one or more game audio systems. In some examples, the game studios may output new stem formats that support audio format. In any case, the game studios may output coded audio content to the rendering engines which may render a soundfield for playback by the delivery systems.

The mobile device may also, in some instances, include a plurality of microphones that are collectively configured to record a soundfield, including 3D soundfields. In other words, the plurality of microphones may have X, Y, Z diversity. In some examples, the mobile device may include a microphone which may be rotated to provide X, Y, Z diversity with respect to one or more other microphones of the mobile device.

A ruggedized video capture device may further be configured to record a soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a soundfield that represents the action all around the user (e.g., water crashing behind the user, another rafter speaking in front of the user, etc. . . . ).

The techniques may also be performed with respect to an accessory enhanced mobile device, which may be configured to record a soundfield, including a 3D soundfield. In some examples, the mobile device may be similar to the mobile devices discussed above, with the addition of one or more accessories. For instance, a microphone, including an Eigen microphone, may be attached to the above noted mobile device to form an accessory enhanced mobile device. In this way, the accessory enhanced mobile device may capture a higher quality version of the soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a soundfield, including a 3D soundfield. Moreover, in some examples, headphone playback devices may be coupled to a decoder via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the soundfield, including 3D soundfields, of the sports game may be acquired (e.g., one or more microphones and/or Eigen microphones may be placed in and/or around the baseball stadium). HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the source device 12 may perform a method or otherwise comprise means to perform each step of the method for which the source device 12 is described above as performing. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the source device 12 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the playback device 14 may perform a method or otherwise comprise means to perform each step of the method for which the playback device 14 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the playback device 14 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, as used herein, “A and/or B” means “A or B”, or both “A and B.”

Various aspects of the techniques have been described. These and other aspects of the techniques are within the scope of the following claims.

1. A device configured to decode a bitstream representative of audio data, the device comprising:
a memory configured to store the bitstream; and
one or more processors configured to:
obtain a reference pool of one or more reference audio frames, each of the one or more reference audio frames representative of a different portion of the audio data;
determine that a current audio frame is unavailable;
obtain, responsive to determining that the current audio frame is unavailable and based on a successive audio frame to the current audio frame in the bitstream, a reference audio frame of the one or more reference audio frames;
replace the current audio frame with the reference audio frame; and
render the reference audio frame to one or more speaker feeds.

2. The device of claim 1,
wherein the audio data includes music audio data, and
wherein the one or more processors are further configured to receive the bitstream via a network as part of an audio streaming service.

3. The device of claim 1,
wherein the audio data correlates with video data, and
wherein the one or more processors are further configured to receive the bitstream via a network as part of a video streaming service.

4. The device of claim 1,
wherein the one or more processors are further configured to assign an index to each of the reference audio frames in the reference pool, and
wherein the one or more processors are configured to:
obtain, from the successive audio frame, an index identifying the reference audio frame of the one or more reference audio frames; and
obtain, from the reference pool, the reference audio frame of the one or more reference audio frames assigned the index obtained from the successive audio frame.

5. The device of claim 1, wherein the one or more processors are further configured to:
obtain, based on the current audio frame, a current representative of the current audio frame;
obtain, for each of the reference audio frames, a reference representative of each of the respective reference audio frames;
compare the current representative to each of the reference representatives to obtain a similarity score relative to each of the reference frames; and
add, based on the similarity scores, the current audio frame to the reference pool as one of the reference audio frames.

6. The device of claim 5,
wherein the current representative comprises a current tuple; and
wherein the reference representatives comprise reference tuples.

7. The device of claim 5, wherein the one or more processors are configured to add, based on a comparison of the similarity scores to a similarity threshold, the current audio frame to the reference pool.

8. The device of claim 5, wherein the one or more processors are configured to maintain, based on a comparison of the similarity scores to a similarity threshold, the reference pool without adding the current audio frame.

9. The device of claim 1, wherein the one or more processors are configured to remove the reference audio frames from the reference pool after a period of time.

10. A method of decoding a bitstream representative of audio data, the method comprising:
obtaining a reference pool of one or more reference audio frames, each of the one or more reference audio frames representative of a different portion of the audio data;
determining that a current audio frame is unavailable;
obtaining, responsive to determining that the current audio frame is unavailable and based on a successive audio frame to the current audio frame in the bitstream, a reference audio frame of the one or more reference audio frames;
replacing the current audio frame with the reference audio frame; and
rendering the reference audio frame to one or more speaker feeds.

11. A non-transitory computer-readable storage medium having stored thereon instructions that, when executed, cause one or more processors to:
obtain a reference pool of one or more reference audio frames, each of the one or more reference audio frames representative of a different portion of audio data; and
determine that a current audio frame is unavailable;
obtain, responsive to determining that the current audio frame is unavailable and based on a successive audio frame to the current audio frame in a bitstream, a reference audio frame of the one or more reference audio frames;
replace the current audio frame with the reference audio frame; and
render the reference audio frame to one or more speaker feeds.

12. A device configured to encode audio data, the device comprising:
a memory configured to store the audio data; and
one or more processors configured to:
obtain a reference pool of one or more reference audio frames, each of the one or more reference audio frames representative of a different portion of the audio data;
identify a reference audio frame of the one or more reference audio frames as being perceptually similar to a current audio frame;
identify, in a successive audio frame to the current audio frame in a bitstream, the identified reference audio frame; and
output the bitstream.

13. The device of claim 12,
wherein the audio data includes music audio data, and
wherein the one or more processors are configured to output the bitstream via a network as part of an audio streaming service.

14. The device of claim 12,
wherein the audio data correlates with video data, and
wherein the one or more processors are configured to output the bitstream via a network as part of a video streaming service.

15. The device of claim 12,
wherein the one or more processors are further configured to assign an index to each of the reference audio frames in the reference pool, and
wherein the one or more processors are configured to specify the index assigned to the identified reference audio frame in the successive audio frame.

16. The device of claim 12, wherein the one or more processors are configured to:
obtain, based on the current audio frame, a current tuple representative of the current audio frame;
obtain, for each of the reference audio frames, a reference tuple representative of each of the respective reference audio frames; and
identify, based on the current tuple and the reference tuples, the reference audio frame of the one or more reference audio frames as being perceptually similar to the current audio frame.

17. The device of claim 12, wherein the one or more processors are further configured to:
obtain, based on the current audio frame, a current representative of the current audio frame;
obtain, for each of the reference audio frames, a reference representative of each of the respective reference audio frames;
compare the current representative to each of the reference representatives to obtain a similarity score relative to each of the reference frames; and
add, based on the similarity scores, the current audio frame to the reference pool as one of the reference audio frames.

18. The device of claim 17,
wherein the current representative comprises a current tuple; and
wherein the reference representatives comprise reference tuples.

19. The device of claim 17, wherein the one or more processors are configured to add, based on a comparison of the similarity scores to a similarity threshold, the current reference frame to the reference pool.

20. The device of claim 17, wherein the one or more processors are configured to maintain, based on a comparison of the similarity scores to a similarity threshold, the reference pool without adding the current audio frame.

21. The device of claim 12, wherein the one or more processors are configured to remove the reference audio frames from the reference pool after a period of time.
